(19) United States
(12) Patent Application Publication
(10) Pub. No.: US 2019/0193149 A1
(43) Pub. Date: Jun. 27, 2019

(54) METAL POWDER FEEDSTOCKS FOR ADDITIVE MANUFACTURING, AND SYSTEM AND METHODS FOR PRODUCING THE SAME

(71) Applicant: ARCONIC INC., Pittsburgh, PA (US)

(72) Inventors: Raymond J. Kilmer, Pittsburgh, PA (US); David W. Heard, Pittsburgh, PA (US)

(21) Appl. No.: 16/290,490

(22) Filed: Mar. 1, 2019

Related U.S. Application Data
(63) Continuation of application No. PCT/US2017/050341, filed on Sep. 6, 2017.
(60) Provisional application No. 62/385,861, filed on Sep. 9, 2016.

(51) Int. Cl. B22F 1/00; B22F 9/04; B22F 3/105; C22C 32/00

(52) U.S. Cl. CPC B22F 1/0014; B22F 9/04; B22F 3/1055; C22C 32/0026; B33Y 10/00; B22F 2009/047; B22F 2003/1057; B22F 2003/1058; B22F 2999/00

(57) ABSTRACT

Systems and methods for producing metal powder feedstocks for additive manufacturing are disclosed. In one embodiment, a method includes first gathering a first feedstock from a first powder supply of an additive manufacturing system, second gathering a second feedstock from a second powder supply of the additive manufacturing system, wherein at least one of the first feedstock and the second feedstock includes metal particles therein, combining the first and second feedstocks, thereby producing a metal powder blend, and providing the metal powder blend to a build space of the additive manufacturing system.

### CROSS-REFERENCE TO RELATED APPLICATION

This application is a continuation of International Patent Application No. PCT/US2017/050341, filed Sep. 6, 2017, which claims priority to U.S. Patent Application No. 62/385,861, filed Sep. 9, 2016, each of which is incorporated herein by reference in its entirety.

### BACKGROUND

Additive manufacturing is defined as “a process of joining materials to make objects from 3D model data, usually layer upon layer, as opposed to subtractive manufacturing methodologies.” ASTM F2792-12a entitled “Standard Terminology for Additively Manufacturing Technologies”. Powders may be used in some additive manufacturing techniques, such as binder jetting, powder bed fusion or directed energy deposition, to produce additively manufactured parts. Metal powders are sometimes used to produce metal-based additively manufactured parts.

### BRIEF DESCRIPTION OF THE DRAWINGS

FIG. 1a is a schematic view of one embodiment of a powder bed additive manufacturing system using an adhesive head.

FIG. 1b is a schematic view of another embodiment of a powder bed additive manufacturing system using a laser.

FIG. 1c is a schematic view of another embodiment of a powder bed additive manufacturing system using multiple powder feed supplies and a laser.

FIG. 2 is a schematic view of another embodiment of a powder bed additive manufacturing system using multiple powder feed supplies to produce a tailored metal powder blend.

FIGS. 3a-3f are schematic, cross-sectional views of additively manufactured products having a first region (400) and a second region (500) different than the first region, where the first region is produced via a first metal powder and the second region is produced via a second metal powder, different than the first metal powder.

FIG. 4 is a schematic, cross-sectional view of an additively manufactured product (1000) having a generally homogenous microstructure.

FIGS. 5a-5d are schematic, cross-sectional views of an additively manufactured product produced from a single metal powder and having a first region (1700) of a metal or a metal alloy and a second region (1800) of a different phase, with FIGS. 5b-5d being deformed relative to the original additively manufactured product illustrated in FIG. 5a.

### DESCRIPTION

Broadly, the present disclosure relates to tailored metal powder feedstocks for use in additive manufacturing, and systems and methods for producing the same. In one aspect, the metal powder feedstock may include at least a first volume of a first particle type (“the first particles”) and a second volume of a second particle type (“the second particles”). The tailored metal powder feedstock may include additional types and volumes of particles (third volumes, fourth volumes, etc.). At least one of the first and second particles comprises metal particles having at least one metal therein. In one embodiment, both of the first and second particles comprise metal particles, and the metal of the particles may be the same or different relative to each of the volume of particles. As described in further detail in Section B, below, the tailored metal powder feedstocks may be produced in-situ in an appropriate additive manufacturing apparatus.

### A. Metal Powder Feedstocks

As used herein, “metal powder” means a material comprising a plurality of metal particles, optionally with some non-metal particles, described below. The metal particles of the metal powder may have pre-selected physical properties and/or pre-selected composition(s), thereby facilitating production of tailored additively manufactured products. The metal powders may be used in a metal powder bed to produce a tailored product via additive manufacturing. Similarly, any non-metal particles of the metal powder may have pre-selected physical properties and/or pre-selected composition(s), thereby facilitating production of tailored additively manufactured products by additive manufacturing. The non-metal powders may be used in a metal powder bed to produce a tailored product via additive manufacturing.

As used herein, “metal particle” means a particle comprising at least one metal. The metal particles may be one-metal particles, multiple metal particles, and metal-non-metal (M-NM) particles, as described below. The metal particles may be produced, as one example, via gas atomization.

As used herein, a “particle” means a minute fragment of matter having a size suitable for use in the powder of the powder bed (e.g., a size of from 5 microns to 100 microns). Particles may be produced, for example, via gas atomization.

For purposes of the present patent application, a “metal” is one of the following elements: aluminum (Al), silicon (Si), lithium (Li), any useful element of the alkaline earth metals, any useful element of the transition metals, any useful element of the post-transition metals, and any useful element of the rare earth elements.

As used herein, useful elements of the alkaline earth metals are beryllium (Be), magnesium (Mg), calcium (Ca), and strontium (Sr).

As used herein, useful elements of the transition metals are any of the metals shown in Table 1, below.

TABLE 1
Transition Metals

| Group | 4 | 5 | 6 | 7 | 8 | 9 | 10 | 11 | 12 |
|---|---|---|---|---|---|---|---|---|---|
| Period 4 | Ti | V | Cr | Mn | Fe | Co | Ni | Cu | Zn |
| Period 5 | Zr | Nb | Mo | | Ru | Rh | Pd | Ag | |
| Period 6 | Hf | Ta | W | Re | | | Pt | Au | |

As used herein, useful elements of the post-transition metals are any of the metals shown in Table 2, below.

TABLE 2
Post-Transition Metals

| Group | 13 | 14 | 15 |
|---|---|---|---|
| Period 4 | Ga | Ge | |
| Period 5 | In | Sn | |
| Period 6 | | Pb | Bi |

As used herein, useful elements of the rare earth elements are scandium, yttrium and any of the fifteen lanthanides elements. The lanthanides are the fifteen metallic chemical elements with atomic numbers 57 through 71, from lanthanum through lutetium.

As used herein non-metal particles are particles essentially free of metals. As used herein “essentially free of metals” means that the particles do not include any metals, except as an impurity. Non-metal particles include, for example, boron nitride (BN) and boron carbide (BC) particles, carbon-based polymer particles (e.g., short or long chained hydrocarbons (branched or unbranched)), carbon nanotube particles, and graphene particles, among others. The non-metal materials may also be in non-particulate form to assist in production or finalization of the additively manufactured product.

In one embodiment, at least some of the metal particles consist essentially of a single metal (“one-metal particles”). The one-metal particles may consist essentially of any one metal useful in producing a product, such as any of the metals defined above. In one embodiment, a one-metal particle consists essentially of aluminum. In one embodiment, a one-metal particle consists essentially of copper. In one embodiment, a one-metal particle consists essentially of manganese. In one embodiment, a one-metal particle consists essentially of silicon. In one embodiment, a one-metal particle consists essentially of magnesium. In one embodiment, a one-metal particle consists essentially of zinc. In one embodiment, a one-metal particle consists essentially of iron. In one embodiment, a one-metal particle consists essentially of titanium. In one embodiment, a one-metal particle consists essentially of zirconium. In one embodiment, a one-metal particle consists essentially of chromium. In one embodiment, a one-metal particle consists essentially of nickel. In one embodiment, a one-metal particle consists essentially of tin. In one embodiment, a one-metal particle consists essentially of silver. In one embodiment, a one-metal particle consists essentially of vanadium. In one embodiment, a one-metal particle consists essentially of a rare earth element.

In another embodiment, at least some of the metal particles include multiple metals (“multiple-metal particles”). For instance, a multiple-metal particle may comprise two or more of any of the metals listed in the definition of metals, above. In one embodiment, a multiple-metal particle consists essentially of an aluminum alloy. In another embodiment, a multiple-metal particle consists essentially of a titanium alloy. In another embodiment, a multiple-metal particle consists essentially of a nickel alloy. In another embodiment, a multiple-metal particle consists essentially of a cobalt alloy. In another embodiment, a multiple-metal particle consists essentially of a chromium alloy. In another embodiment, a multiple-metal particle consists essentially of a steel.

In one embodiment, at least some of the metal particles of the metal powder are metal-nonmetal (M-NM) particles. Metal-nonmetal (M-NM) particles include at least one metal with at least one non-metal. Examples of non-metal elements include oxygen, carbon, nitrogen and boron. Examples of M-NM particles include metal oxide particles (e.g., Al₂O₃), metal carbide particles (e.g., TiC), metal nitride particles (e.g., Si₃N₄), metal borides (e.g., TiB₂), and combinations thereof.

The metal particles and/or the non-metal particles of the tailored metal powder feedstock may have tailored physical properties. For example, the particle size, the particle size distribution of the powder, and/or the shape of the particles may be pre-selected. In one embodiment, one or more physical properties of at least some of the particles are tailored in order to control at least one of the density (e.g., bulk density and/or tap density), the flowability of the metal powder, and/or the percent void volume of the metal powder bed (e.g., the percent porosity of the metal powder bed). For example, by adjusting the particle size distribution of the particles, voids in the powder bed may be restricted, thereby decreasing the percent void volume of the powder bed. In turn, additively manufactured products having an actual density close to the theoretical density may be produced. In this regard, the metal powder may comprise a blend of powders having different size distributions. For example, the metal powder may comprise a blend of the first particles having a first particle size distribution and the second particles having a second particle size distribution, wherein the first and second particle size distributions are different. The metal powder may further comprise a third particles having a third particle size distribution, a fourth particles having a fourth particle size distribution, and so on. Thus, size distribution characteristics such as median particle size, average particle size, and standard deviation of particle size, among others, may be tailored via the blending of different metal powders having different particle size distributions.

In one embodiment, a final additively manufactured product realizes a density within 98% of the product's theoretical density. In another embodiment, a final additively manufactured product realizes a density within 98.5% of the product's theoretical density. In yet another embodiment, a final additively manufactured product realizes a density within 99.0% of the product's theoretical density. In another embodiment, a final additively manufactured product realizes a density within 99.5% of the product's theoretical density. In yet another embodiment, a final additively manufactured product realizes a density within 99.7%, or higher, of the product's theoretical density.

The tailored metal powder feedstock may comprise any combination of one-metal particles, multiple-metal particles, M-NM particles and/or non-metal particles to produce the additively manufactured product, and, optionally, with any pre-selected physical property.

For example, the metal powder may comprise a blend of a first type of metal particle with a second type of particle (metal or non-metal), wherein the first type of metal particle is a different type than the second type (compositionally different, physically different or both). The metal powder may further comprise a third type of particle (metal or non-metal), a fourth type of particle (metal or non-metal), and so on. The metal powder may be the same metal powder throughout the additive manufacturing of the additively manufactured product, or the metal powder may be varied during the additive manufacturing process.

### B. Additive Manufacturing

As described above, the tailored metal powder feedstocks are used in at least one additive manufacturing operation. As used herein, “additive manufacturing” means “a process of joining materials to make objects from 3D model data, usually layer upon layer, as opposed to subtractive manufacturing methodologies”, as defined in ASTM F2792-12a entitled “Standard Terminology for Additively Manufacturing Technologies”. The additively manufactured products described herein may be manufactured via any appropriate additive manufacturing technique described in this ASTM standard that utilizes particles, such as binder jetting, directed energy deposition, material jetting, or powder bed fusion, among others.

In one embodiment, a metal powder bed is used to create an additively manufactured product (e.g., a tailored additively manufactured product). As used herein a “metal powder bed” means a bed comprising a metal powder. During additive manufacturing, particles of different compositions may melt (e.g., rapidly melt) and then solidify (e.g., in the absence of homogenous mixing). Thus, additively manufactured products having a homogenous or non-homogeneous microstructure may be produced.

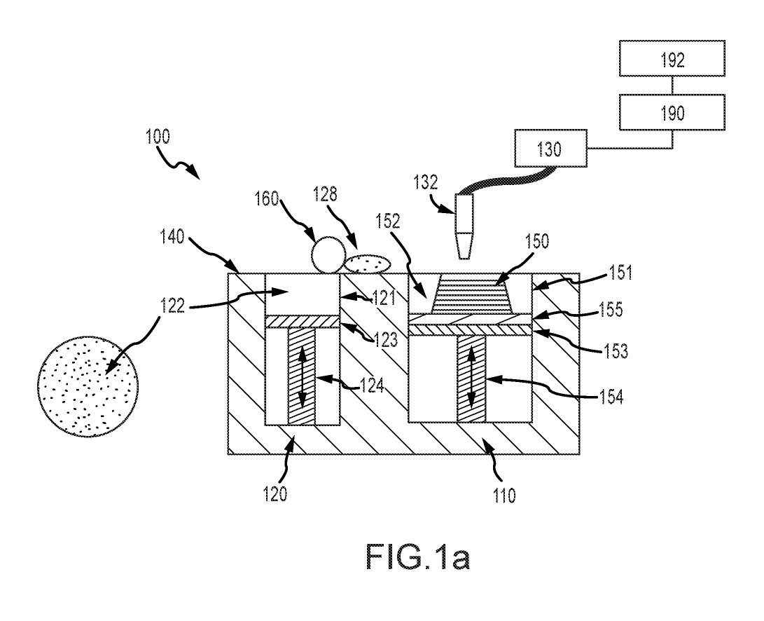

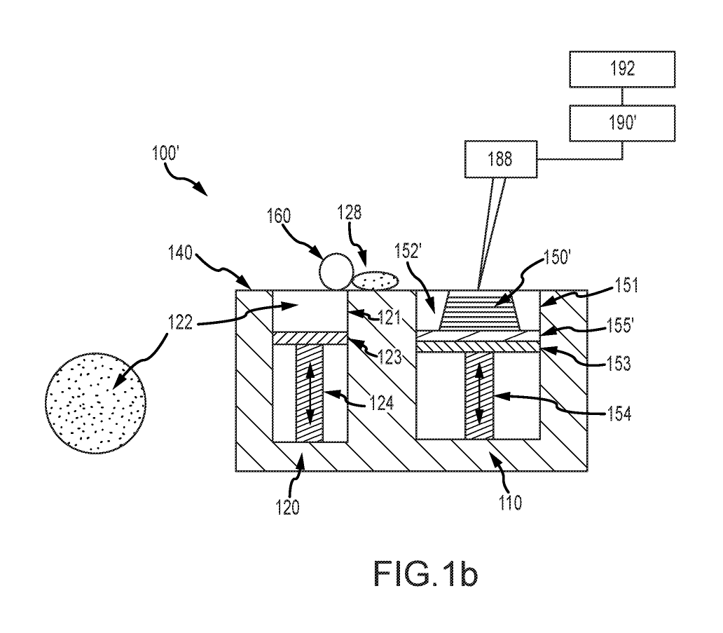

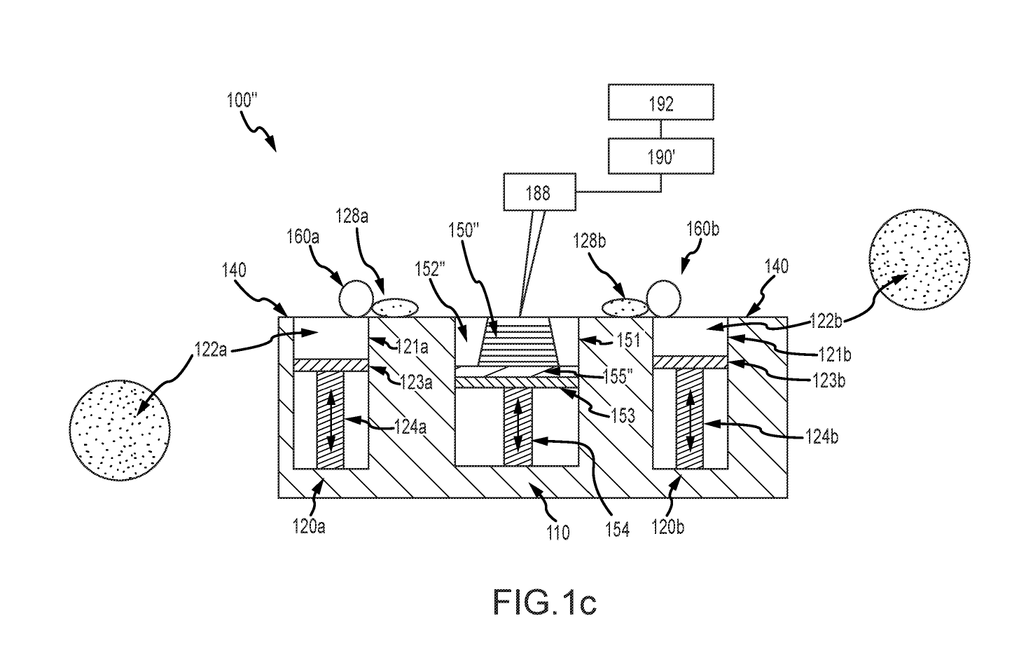

One approach for producing a tailored additively manufactured product using a metal powder bed arrangement is illustrated in FIG. 1a. In the illustrated approach, the system (100) includes a powder bed build space (110), a powder supply (120), and a powder spreader (160). The powder supply (120) includes a powder reservoir (121), a platform (123), and an adjustable device (124) coupled to the platform (123). The adjusting device (124) is adjustable (via a control system, not shown) to move the platform (123) up and down within the powder reservoir (121). The build space (110) includes a build reservoir (151), a build platform (153), and an adjustable device (154) coupled to the build platform (153). The adjustable device (154) is adjustable (via a control system, not shown) to move the build platform (153) up and down within the build reservoir (151), as appropriate, to facilitate receipt of metal powder feedstock (122) from the powder supply (120) and/or production of a tailored 3-D metal part (150).

Powder spreader (160) is connected to a control system (not shown) and is operable to move from the powder reservoir (121) to the build reservoir (151), thereby supplying preselected amount(s) of powder feedstock (122) to the build reservoir (151). In the illustrated embodiment, the powder spreader (160) is a roller and is configured to roll along a distribution surface (140) of the system to gather a preselected volume (128) of powder feedstock (122) and move this preselected volume (128) of powder feedstock (122) to the build reservoir (151) (e.g., by pushing/rolling the powder feedstock). For instance, platform (123) may be moved to the appropriate vertical position, wherein a preselected volume (128) of the powder feedstock (122) lies above the distribution surface (140). Correspondingly, the build platform (153) of the build space (110) may be lowered to accommodate the preselected volume (128) of the powder feedstock (122). As powder spreader (160) moves from an entrance side (the left-hand side in FIG. 1a) to an exit side (the right-hand side of FIG. 1a) of the powder reservoir (121), the powder spreader (160) will gather most or all of the preselected volume (128) of the powder feedstock (122). As powder spreader (160) continues along the distribution surface (140), the gathered volume of powder (128) will be moved to the build reservoir (151) and distributed therein, such as in the form of a layer of metal powder. The powder spreader (160) may move the gathered volume (128) of the metal powder feedstock (122) into the build reservoir (151), or may move the gathered volume (128) onto a surface co-planar with the distribution surface (140), to produce a layer of metal powder feedstock. In some embodiments, the powder spreader (160) may pack/densify the gathered powder (128) within the build reservoir (151). While the powder spreader (160) is shown as being a cylindrical roller, the spreader may be of any appropriate shape, such as rectangular (e.g., when a squeegee is used), or otherwise. In this regard, the powder spreader (160) may roll, push, scrape, or otherwise move the appropriate gathered volume (128) of the metal powder feedstock (122) to the build reservoir (151), depending on its configuration. Further, in other embodiments (not illustrated) a hopper or similar device may be used to provide a powder feedstock to the distribution surface (140) and/or directly to the build reservoir (151).

After the powder spreader (160) has distributed the gathered volume of powder (128) to the build reservoir (151), the powder spreader (160) may then be moved away from the build reservoir (151), such as to a neutral position, or a position upstream (to the left of in FIG. 1a) of the entrance side of the powder reservoir (121). Next, the system (100) uses an adhesive supply (130) and its corresponding adhesive head (132) to selectively provide (e.g., spray) adhesive to the gathered volume of powder (128) contained in the build reservoir (151). Specifically, the adhesive supply (130) is electrically connected to a computer system (192) having a 3-D computer model of a 3-D part, and a controller (190). After the gathered volume (128) of the powder has been provided to the build reservoir (151), the controller (190) of the adhesive supply (130) moves the adhesive head (132) in the appropriate X-Y directions, spraying adhesive onto the powder volume in accordance with the 3-D computer model of the computer (192).

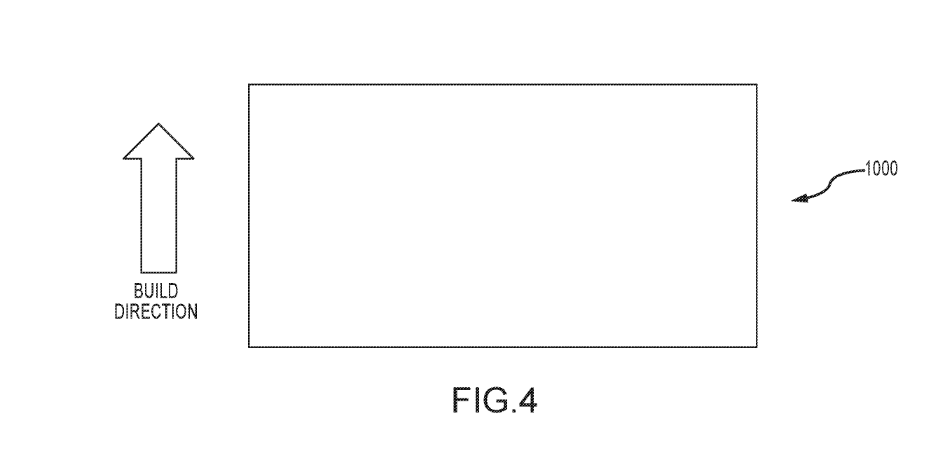

Upon conclusion of the adhesive spraying step, the build platform (153) may be lowered, the powder supply platform (123) may be raised, and the process repeated, with multiple gathered volumes (128) being serially provided to the build reservoir (151) via powder spreader (160), until a multi-layer, tailored 3-D part (150) is completed. As needed, a heater (not illustrated) may be used between one or more spray operations to cure (e.g., partially cure) any powder sprayed with adhesive. The final tailored 3-D part (150) may then be removed from the build space (110), wherein excess powder (152) (not having being substantively sprayed by the adhesive) is removed, leaving only the final “green” tailored 3-D part (150). The final green tailored 3-D part (150) may then be heated in a furnace or other suitable heating apparatus, thereby sintering the part and/or removing volatile component(s) (e.g., from the adhesive supply) from the part. In one embodiment, the final tailored 3-D part (150) comprises a homogenous or near homogenous distribution of the metal powder feedstock (e.g., as shown in FIG. 4). Optionally, a build substrate (155) may be used to build the final tailored 3-D part (150), and this build substrate (155) may be incorporated into the final tailored 3-D part (150), or the build substrate may be excluded from the final tailored 3-D part (150). The build substrate (155) itself may be a metal or metallic product (different or the same as the 3-D part), or may be another material (e.g., a plastic or a ceramic).

As described above, the powder spreader (160) may move the gathered volume (128) of metal powder feedstock (122) to the build reservoir (151) via distribution surface (140). In another embodiment, at least one of the build space (110) and the powder supply (120) are operable to move in the lateral direction (e.g., in the X-direction) such that one or more outer surfaces of the build space (110) and powder supply (120) are in contact. In turn, powder spreader (160) may move the preselected volume (128) of the metal powder feedstock (122) to the build reservoir (151) directly and in the absence of any intervening surfaces between the build reservoir (151) and the powder reservoir (121).

As noted, the powder supply (120) includes an adjustable device (124) which is adjustable (via a control system, not shown) to move the platform (123) up and down within the powder reservoir (151). In one embodiment, the adjustable device (124) is in the form of a screw or other suitable mechanical apparatus. In another embodiment, the adjustable device (124) is a hydraulic device. Likewise, the adjustable device (154) of the build space may be a mechanical apparatus (e.g., a screw) or a hydraulic device.

As noted above, the powder reservoir (121) includes a metal powder feedstock (122). This powder feedstock (122) may include one-metal particles, multiple-metal particles, M-NM particles, non-metal particles, and combinations thereof, wherein at least one of the one-metal particles, multiple-metal particles, and/or M-NM particles is present. Thus, tailored 3-D metal-containing parts may be produced. In one embodiment, at least 50 vol. % of the powder feedstock (122) comprises one-metal particles, multiple-metal particles, M-NM particles and combinations thereof. In another embodiment, at least 75 vol. % of the powder feedstock (122) comprises one-metal particles, multiple-metal particles, M-NM particles and combinations thereof. In another embodiment, at least 90 vol. % of the powder feedstock (122) comprises one-metal particles, multiple-metal particles, M-NM particles and combinations thereof.

In one embodiment, the powder feedstock (122) includes a sufficient amount of the one-metal particles, multiple-metal particles, M-NM particles, non-metal particles, and combinations thereof to make an aluminum-based 3-D part. In one embodiment, the powder feedstock (122) includes a sufficient amount of the one-metal particles, multiple-metal particles, M-NM particles, non-metal particles, and combinations thereof to make a titanium-based 3-D part. In one embodiment, the powder feedstock (122) includes a sufficient amount of the one-metal particles, multiple-metal particles, M-NM particles, non-metal particles, and combinations thereof to make a cobalt-based 3-D part. In one embodiment, the powder feedstock (122) includes a sufficient amount of the one-metal particles, multiple-metal particles, M-NM particles, non-metal particles, and combinations thereof to make a nickel-based 3-D part. In one embodiment, the powder feedstock (122) includes a sufficient amount of the one-metal particles, multiple-metal particles, M-NM particles, non-metal particles, and combinations thereof to make an iron-based 3-D part. An aluminum-based part includes aluminum as the majority component. A titanium-based part includes titanium as the majority component. A cobalt-based part includes titanium as the majority component. A nickel-based part includes titanium as the majority component. An iron-based part includes iron as the majority component. In one embodiment, the 3-D part is an aluminum alloy. In another embodiment, the 3-D part is a titanium alloy. In another embodiment, the 3-D part is a cobalt alloy. In another embodiment, the 3-D part is a nickel alloy. In one embodiment, the 3-D part is a steel.

In one approach, the powder feedstock (122) includes a sufficient amount of the one-metal particles, multiple-metal particles, M-NM particles, non-metal particles, and combinations thereof to make a metal matrix composite 3-D part. A metal matrix composite has a metal matrix with M-NM and/or non-metal features therein. In one embodiment, the powder feedstock (122) includes a sufficient amount of the one-metal particles, multiple-metal particles, M-NM particles, non-metal particles, and combinations thereof to make an oxide dispersion strengthened 3-D metal alloy part. In one embodiment, the 3-D metal part is an aluminum alloy containing not greater than 10 wt. % oxides. In one embodiment, the 3-D metal part is a titanium alloy containing not greater than 10 wt. % oxides. In one embodiment, the 3-D metal part is a nickel alloy containing not greater than 10 wt. % oxides. In this regard, the metal powder feedstock may include M-O particles, where M is a metal and O is oxygen. Suitable M-O particles include Y₂O₃, Al₂O₃, TiO₂, and La₂O₃, among others.

FIG. 1b utilizes generally the same configuration as FIG. 1a, but uses a laser system (188) (or an electron beam) in lieu of an adhesive system to produce a 3-D product (150′). All the embodiments and descriptions of FIG. 1a, therefore, apply to the embodiment of FIG. 1b, with the exception of the adhesive supply (130). Instead, a laser (188) is electrically connected to the computer system (192) having a 3-D computer model of a 3-D part, and a suitable controller (190′). After a gathered volume (128) of the powder has been provided to the build reservoir (151), the controller (190′) of the laser (188) moves the laser (188) in the appropriate X-Y directions, heating selective portions of the powder volume in accordance with the 3-D computer model of the computer (192). In doing so, the laser (188) may heat a portion of the powder to a temperature above the liquidus temperature of the product to be formed, thereby forming a molten pool. The laser may be subsequently moved and/or powered off (e.g., via controller 190′), thereby cooling the molten pool at a cooling rate of at least 1,000° C. per second, thereby forming a portion of the final tailored 3-D part (150′). In one embodiment, the cooling rate is at least 10,000° C. per second. In another embodiment, the cooling rate is at least 100,000° C. per second. In another embodiment, the cooling rate is at least 1,000,000° C. per second. Upon conclusion of the lasing process, the build platform (153) may be lowered, and the process repeated until the multi-layer, tailored 3-D part (150′) is completed. As described above, the final tailored 3-D part may then be removed from the build space (110), wherein excess powder (152′) (not having being substantively lased) is removed. When an electron beam is used as the laser (188), the cooling rates may be at least 10° C. per second (inherently or via controlled cooling), thereby forming a portion of the final tailored 3-D part (150′).

In one embodiment, the build space (110), includes a heating apparatus (not shown), which may intentionally heat one or more portions of the build reservoir (151) of the build space (110), or powders or lased objects contained therein. In one embodiment, the heating apparatus heats a bottom portion of the build reservoir (151). In another embodiment, the heating apparatus heats one or more side portions of the build reservoir (151). In another embodiment, the heating apparatus heats at least portions of the bottom and sides of the build reservoir (151). The heating apparatus may be useful, for instance, to control the cooling rate and/or relax residual stress(es) during cooling of the lased 3-D part (150′). Thus, higher yields may be realized for some metal products. In one embodiment, controlled heating and cooling are used to produce controlled local thermal gradients within one or more portions of the lased 3-D part (150′). The controlled local thermal gradients may facilitate, for instance, tailored textures within the final lased 3-D part (150′). The system of FIG. 1b can use any of the metal powder feedstocks described herein. Further, a build substrate (155′) may be used to build the final tailored 3-D part (150′), and this build substrate (155′) may be incorporated into the final tailored 3-D part (150′), or the build substrate may be excluded from the final tailored 3-D part (150′). The build substrate (155′) itself may be a metal or metallic product (different or the same as the 3-D part), or may be another material (e.g., a plastic or a ceramic).

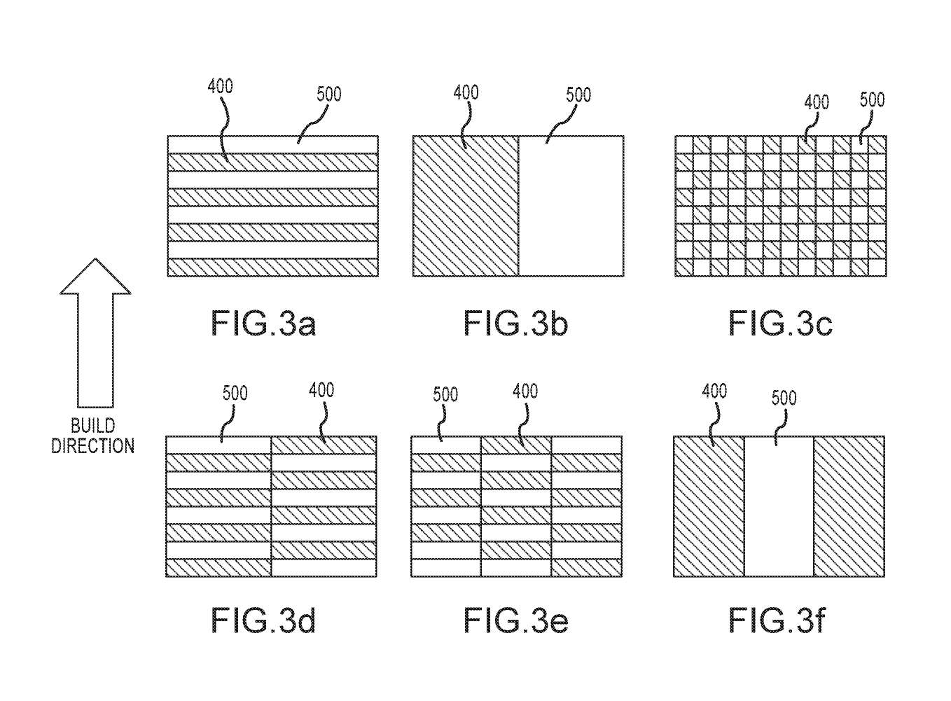

In another approach, and referring now to FIG. 1c, multiple powder supplies (120a, 120b) may be used to feed multiple powder feedstocks (122a, 122b) to the build reservoir (151) to facilitate production of tailored metal 3-D products. In the embodiment of FIG. 1c, a first powder spreader (160a) may feed a first powder feedstock (122a) of the first powder supply (120a) to the build reservoir (151), and second powder spreader (160b) may feed a second powder feedstock (122b) of the second powder supply (120b) to the build reservoir (151). The first and second powder feedstocks (122a, 122b) may be provided in any suitable amount and in any suitable order to facilitate production of tailored metal 3-D products. As one specific example, a first layer of a 3-D product may be produced using the first powder feedstock (122a), and as described above relative to FIGS. 1a-1b. A second layer of the 3-D product may be subsequently produced using the second powder feedstock (122b), and as described above relative to FIGS. 1a-1b. Thus, tailored metal 3-D products may be produced. In one embodiment, the second layer overlies the first layer (e.g., as shown in FIG. 3a, showing second portions (500) overlaying first portion (400)). In another embodiment, the first and second layers are separated by other materials (e.g., a third layer of a third material).

As another example, the first powder spreader (160a) may only partially provide the first feedstock (122a) to the build reservoir (151) specifically and intentionally leaving a gap. Subsequently, the second powder spreader (160b) may provide the second feedstock (122b) to the build reservoir (151), at least partially filling the gap. The laser (188) may be utilized at any suitable time(s) relative to these first and second rolling operations. In turn, multi-region 3-D products may be produced with a first portion (400) being laterally adjacent to the second portion (500) (e.g., as shown in FIG. 3b). Indeed, the system (100″) may operate the build space (110), the powder supplies (120a, 120b) and the powder spreader (160a, 160b), as appropriate, to produce any of the embodiments illustrated in FIGS. 3a-3f.

The first and second powder feedstocks (122a, 122b) may have the same compositions (e.g., for speed/efficiency purposes), but generally have different compositions. At least one of the first and second powder feedstocks (122a, 122b) include one-metal particles, multiple-metal particles, M-NM particles, non-metal particles, and combinations thereof, wherein at least one of the one-metal particles, multiple-metal particles, and/or M-NM particles is present. Thus, tailored 3-D metal-containing parts may be produced. In one embodiment, at least 50 vol. % of the first and/or second powder feedstocks (122a, 122b) comprise one-metal particles, multiple-metal particles, M-NM particles and combinations thereof. In another embodiment, at least 75 vol. % of the first and/or second powder feedstocks (122a, 122b) comprise one-metal particles, multiple-metal particles, M-NM particles and combinations thereof. In another embodiment, at least 90 vol. % of the first and/or second powder feedstocks (122a, 122b) comprise one-metal particles, multiple-metal particles, M-NM particles and combinations thereof.

Any combinations of first and second feedstocks (122a, 122b) can be used to produce tailored metal 3-D products. In one approach, the first feedstock (122a) comprises a first composition blend and the second feedstock (122b) comprises a second composition blend, different than the first composition. However, each of the first and second powder feedstock (122a, 122b) still includes at least one of the one-metal particles, multiple-metal particles, and/or M-NM particles. In one approach, the first composition and the second composition are at least partially overlapping, where the first and second feedstocks (122a, 122b) include at least one common metal element, which metal element may be included in one-metal particles, multiple-metal particles, and/or M-NM particles. In another approach, the first composition and the second composition are non-overlapping, where the first and second feedstocks (122a, 122b) do not include any of the same metal elements in the one-metal, multiple-metal or M-NM particles.

As with the approaches of FIGS. 1a-1b, above, while the powder spreaders (160a, 160b) are shown as being cylindrical, the powder spreaders (160a, 160b) may be of any appropriate shape, such as rectangular or otherwise. In this regard, the powder spreaders (160a, 160b) may roll, push, scrape, or otherwise move the feedstocks (122a, 122b) to the build reservoir (151), depending on their configurations. Also, optionally, a build substrate (155″) may be used to build the final tailored 3-D part (150″), and this build substrate (155″) may be incorporated into the final tailored 3-D part (150″), or the build substrate may be excluded from the final tailored 3-D part (150″). The build substrate (155″) itself may be a metal or metallic product (different or the same as the 3-D part), or may be another material (e.g., a plastic or a ceramic). Although FIG. 1c is illustrated as using a laser (188), the system of FIG. 1c could alternatively use an adhesive system as described above relative to FIG. 1a.

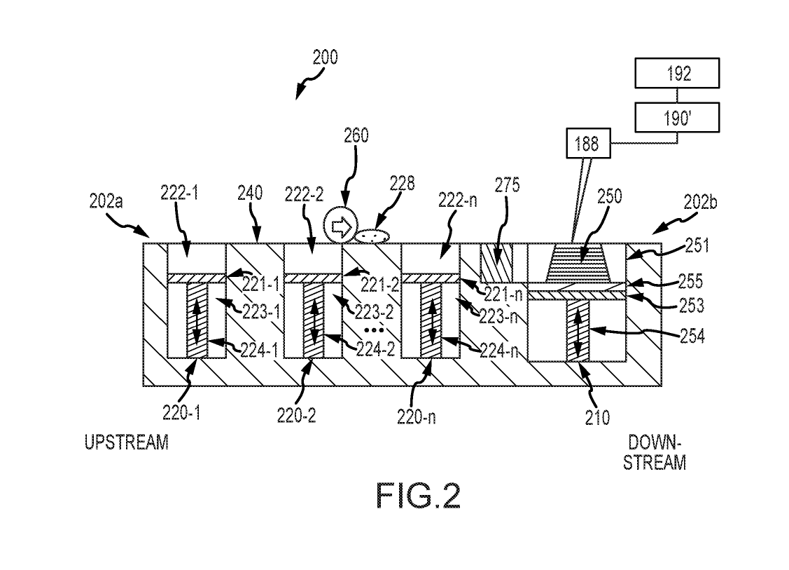

FIG. 2 is a schematic view of a system (200) for making a multi-powder feedstock (222). In the illustrated embodiment, the system (200) is shown as providing a multi-powder feedstock to a powder bed build space (110), such as those described above relative to FIGS. 1a-1c, however, the system (200) could be used to produce multi-component powders for any suitable additive manufacturing method.

The system (200) of FIG. 2 includes a plurality of powder supplies (220-1, 220-2, to 220-n) and a corresponding plurality of powder reservoirs (221-1, 221-2, to 221-n), powder feedstocks (222-1, 222-2, to 222-n), platforms (223-1, 223-2, to 223-n), and adjustment devices (224-1, 224-2, to 224-n), as described above relative to FIGS. 1a-1c. Likewise, build space (210) includes a build reservoir (251), a build platform (253), and an adjustable device (254) coupled to the build platform (253), as described above relative to FIGS. 1a-1c.

A powder spreader (260) may be operable to move between (to and from) a first position (202a) and a second position (202b), the first position being upstream of the first powder supply (220-1), and the second position (202b) being downstream of either the last powder supply (220-n) or the build space (210). As powder spreader (260) moves from the first position (202a) towards the second position (202b), it will gather the appropriate volume of first feedstock (222-1) from the first powder supply (220-1), the appropriate volume of second feedstock (220-2) from the second powder supply (222-2), and so forth, thereby producing a gathered volume (228). The volumes and compositions of the first through final feedstocks (220-1 to 220-n) can be tailored and controlled for each rolling cycle to facilitate production of tailored 3-D products, or portions thereof.

For instance, the first powder supply (220-1) may include a first metal powder (e.g., a one-metal powder) as its feedstock (222-1), and the second powder supply (220-2) may include a second metal powder (e.g., a multi-metal powder) as its feedstock (222-2). As powder spreader (260) moves from upstream of the first powder supply (220-1), along distribution surface (240), to downstream of the second powder supply (220-2), the powder spreader (260) may gather the first and second volumes of metal powders (222-1, 222-2), thereby producing a tailored powder blend (228) downstream of the second powder supply (220-2). As powder spreader (260) moves towards build reservoir (251), the first and second powders may mix (e.g., by tumbling, by applying vibration to upper surface (240), e.g., via optional vibratory apparatus (275) or by other mixing/stirring means). Subsequent powder feedstocks (222-3 (not shown) to 222-n) may be utilized or avoided (e.g., by closing the top of the powder supply(ies)) as powder spreader (260) moves towards the second position (202b). Ultimately, a final powder feedstock (222=222_{1+2+ . . . n}) may be provided for additive manufacturing, such as for use in powder bed build space (210). A laser (188) may then be used, as described above relative to FIG. 1b, to produce a portion of the final tailored 3-D part (250).

The flexibility of the system (200) facilitates the in-situ production of any of the products illustrated in FIGS. 3a-3f, 4, and 5a-5d, among others. Any suitable powders having any suitable composition, and any suitable particle size distributions may be used as the feedstocks (222-1 to 222-n) of the system (200). For instance, to produce a homogenous 3-D product, such as that illustrated in FIG. 4, generally the same volumes and compositions for each rolling cycle may be utilized. To produced multi-region products, such as those illustrated in FIGS. 3a-3f, the powder spreader (260) may gather different volume(s) of feedstocks from the same or different powder supplies, as appropriate. As one example, to produce the layered product of FIG. 3a, a first rolling cycle may gather a first volume of feedstock (222-1) from the first powder supply (220-1), and a second volume of feedstock (222-2) from the second powder supply (220-2). For a subsequent cycle, and to produce a second, different layer, the height of the first powder supply (220-1) may be adjusted (via its platform) to provide a different volume of the first feedstock (222-1) (the height of the second powder supply (220-2) may remain the same or may also change). In turn, a different powder blend will be produced due to the different volume of the first feedstock utilized in the subsequent cycle, thereby producing a different layer of material.

As an alternative, the system (200) may be controlled such that powder spreader (260) only gathers materials from the appropriate powder supplies (220-2 to 220-n) to produce the desired material layers. For instance, the powder spreader (260) may be controlled to avoid the appropriate powder supplies (e.g., moving non-linearly to avoid). As another example, the powder supplies (220-1 to 220-n) may include selectively operable lids or closures, such that the system (200) can remove any appropriate powder supplies (220-1 to 220-n) from communicating with the powder spreader (260) for any appropriate cycle by selectively closing such lids or closures.

The powder spreader (260) may be controlled via a suitable control system to move from the first position (202a) to the second position (202b), or any positions therebetween. For instance, after a cycle, the powder spreader (260) may return to a position downstream of the first powder supply (220-1), and upstream of the second powder supply (220-2) to facilitate gathering of the appropriate volume of the second feedstock (222-2), avoiding the first feedstock (222-1) altogether. Further, the powder spreader (260) may be moved in a linear or non-linear fashion, as appropriate to gather the appropriate amounts of the feedstocks (222-1 to 222-n) for the additive manufacturing operation. Also, multiple rollers can be used to move and/or blend the feedstocks (222-1 to 222-n). Finally, while more than two powder supplies (222-1 to 222-n) are illustrated in FIG. 2, two powder supplies (222-1 to 222-2) may be useful as well.

C. Non-Limiting Examples of Additively Manufactured 3-D Metal Products Producible by the Apparatus and Systems of FIGS. 1a-1c and 2

As noted above, the additive manufacturing apparatus and systems described in FIGS. 1a-1c and 2 may be used to make any suitable metal-containing 3-D product. In one embodiment, the same general powder is used throughout the additive manufacturing process to produce a final tailored 3-D metal product. For instance, and referring now to FIG. 4, a final tailored product (1000) may comprise a single region produced by using generally the same metal powder during the additive manufacturing process. In one embodiment, a metal powder consists of one-metal particles. In one embodiment, a metal powder consists of a mixture of one-metal particles and multiple-metal particles. In one embodiment, a metal powder consists of one-metal particles and M-NM particles. In one embodiment, a metal powder consists of one-metal particles, multiple-metal particles and M-NM particles. In one embodiment, a metal powder consists of multiple-metal particles. In one embodiment, a metal powder consists of multiple-metal particles and M-NM particles. In one embodiment, a metal powder consists of M-NM particles. In any of these embodiments, non-metal particles may be optionally used in the metal powder. In any of these embodiments, multiple different types of the one-metal particles, the multiple-metal particles, the M-NM particles, and/or the non-metal particles may be used to produce the metal powder. For instance, a metal powder consisting of one-metal particles may include multiple different types of one-metal particles. As another example, a metal powder consisting of multiple-metal particles may include multiple different types of multiple-metal particles. As another example, a metal powder consisting of one-metal and multiple metal particles may include multiple different types of one-metal and/or multiple metal particles. Similar principles apply to M-NM and non-metal particles.

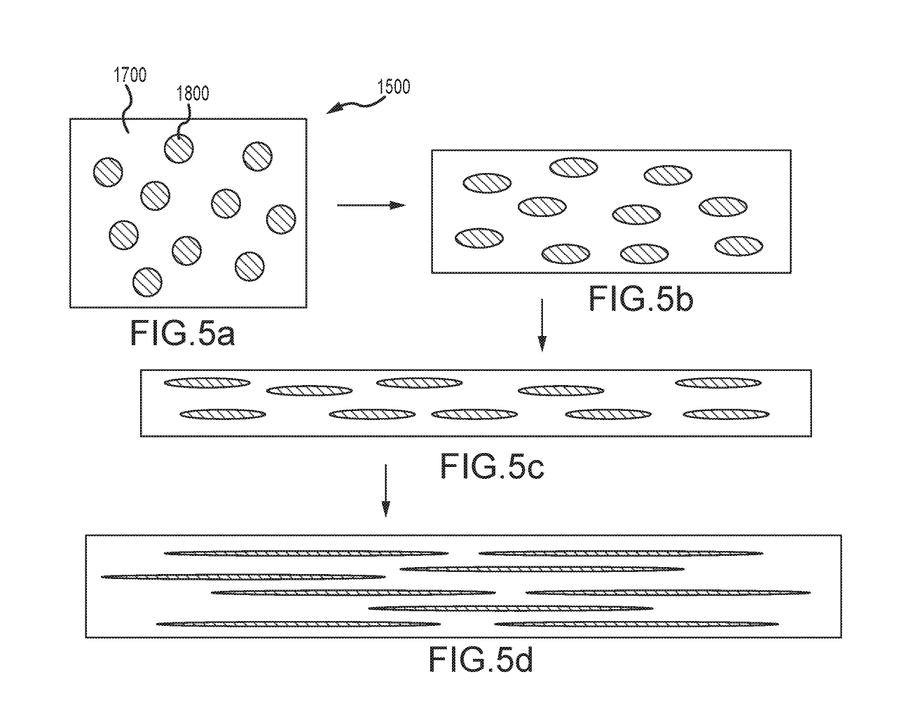

As one specific example, and with reference now to FIGS. 5a-5d, the single metal powder may include a blend of (1) at least one of (a) M-NM particles and (b) non-metal particles (e.g., BN particles) and (2) at least one of (a) one-metal particles or (b) multiple-metal particles. The single powder blend may be used to produce a body (1500) having a large volume of a first region (1700) and smaller volume of a second region (1800). For instance, the first region (1700) may comprise a metal or metal alloy region (e.g., due to the one-metal particles and/or multiple metal particles), such as any of the metal alloys described above, and the second region (1800) may comprise an M-NM region (e.g., due to the M-NM particles and/or the non-metal particles). After or during production, an additively manufactured product comprising the first region (1700) and the second region (1800) may be deformed (e.g., by one or more of rolling, extruding, forging, stretching, compressing), as illustrated in FIGS. 5b-5d. The final deformed product may realize, for instance, higher strength due to the interface between the first region (1700) and the M-NM second region (1800), which may restrict planar slip.

The final tailored product may alternatively comprise at least two separately produced distinct regions. In one embodiment, different metal powder types may be used to produce a 3-D product. For instance, a first metal powder supply may comprise a first metal powder and a second metal powder supply may comprise a second metal powder, different than the first metal powder (e.g., as illustrated in FIGS. 1c and 2). The first metal powder supply may be used to produce a first layer or portion of a 3-D product, and the second metal powder supply may be used to produce a second layer or portion of the 3-D product. For instance, and with reference now to FIGS. 3a-3f, a first region (400) and a second region (500), may be present. To produce the first region (400), a first portion (e.g., a layer) of a build reservoir may comprise a first metal powder from a first powder supply. To produce the second region (500), a second portion (e.g., a layer) of a build reservoir metal powder may comprise a second metal powder from a second metal powder supply, the second metal powder being different than the first layer (compositionally and/or physically different). Third distinct regions, fourth distinct regions, and so on can be produced. Thus, the overall composition and/or physical properties of the metal powder during the additive manufacturing process may be pre-selected, resulting in tailored metal or metal alloy products having tailored compositions and/or microstructures.

In one aspect, the first metal powder of a first powder supply consists of one-metal particles. The first metal powder may be used in a first metal powder bed layer to produce a first region (400) of a tailored 3-D metal body. Subsequently, a second metal powder of a second powder supply may be used as a second metal powder bed layer to produce a second region (500) of a tailored 3-D metal body (e.g., as per FIG. 1c or FIG. 2), or may be blended with the first metal powder prior to being provided to the build reservoir (e.g., as per FIG. 2). In one embodiment, the second metal powder consists of another type of one-metal particles. In another embodiment, the second metal powder consists of one-metal particles and multiple-metal particles. In yet another embodiment, the second metal powder consists of one-metal particles and M-NM particles. In another embodiment, the second metal powder consists of one-metal particles, multiple-metal particles and M-NM particles. In yet another embodiment, the second metal powder consists of multiple-metal particles. In another embodiment, the second metal powder consists of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder of a first powder supply consists of multiple-metal particles. The first metal powder may be used in a first metal powder bed layer to produce a first region (400) of a tailored 3-D metal body. Subsequently, a second metal powder of a second powder supply may be used as a second metal powder bed layer to produce a second region (500) of a tailored 3-D metal body (e.g., as per FIG. 1c or FIG. 2), or may be blended with the first metal powder prior to being provided to the build reservoir (e.g., as per FIG. 2). In one embodiment, the second metal powder consists of another type of multiple-metal particles. In another embodiment, the second metal powder consists of one-metal particles. In yet another embodiment, the second metal powder consists of a mixture of one-metal particles and multiple-metal particles. In another embodiment, the second metal powder consists of a mixture of one-metal particles and M-NM particles. In yet another embodiment, the second metal powder consists of one-metal particles, multiple-metal particles and M-NM particles. In another embodiment, the second metal powder consists of a mixture of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder of a first powder supply consists of M-NM particles. The first metal powder may be used in a first metal powder bed layer to produce a first region (400) of a tailored 3-D metal body. Subsequently, a second metal powder of a second powder supply may be used as a second metal powder bed layer to produce a second region (500) of a tailored 3-D metal body (e.g., as per FIG. 1c or FIG. 2), or may be blended with the first metal powder prior to being provided to the build reservoir (e.g., as per FIG. 2). In one embodiment, the second metal powder consists of another type of M-NM particles. In another embodiment, the second metal powder consists of one-metal particles. In yet another embodiment, the second metal powder consists of one-metal particles and multiple-metal particles. In another embodiment, the second metal powder consists of one-metal particles and M-NM particles. In yet another embodiment, the second metal powder consists of one-metal particles, multiple-metal particles and M-NM particles. In another embodiment, the second metal powder consists of multiple-metal particles. In another embodiment, the second metal powder consists of multiple-metal particles and M-NM particles. In any of these embodiments, non-metal particles may be optionally used in the second metal powder to produce the second region.

In another aspect, the first metal powder of a first powder supply consists of a mixture of one-metal particles and multiple-metal particles. The first metal powder may be used in a first metal powder bed layer to produce a first region (400) of a tailored 3-D metal body. Subsequently, a second metal powder of a second powder supply may be used as a second metal powder bed layer to produce a second region (500) of a tailored 3-D metal body (e.g., as per FIG. 1c or FIG. 2), or may be blended with the first metal powder prior to being provided to the build reservoir (e.g., as per FIG. 2). In one embodiment, the second metal powder consists of another mixture of one-metal particles and multiple metal particles. In another embodiment, the second metal powder consists of one-metal particles. In yet another embodiment, the second metal powder consists of one-metal particles and M-NM particles. In another embodiment, the second metal powder consists of one-metal particles, multiple-metal particles and M-NM particles. In yet another embodiment, the second metal powder consists of multiple-metal particles. In another embodiment, the second metal powder consists of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder of a first powder supply consists of a mixture of one-metal particles and M-NM particles. The first metal powder may be used in a first metal powder bed layer to produce a first region (400) of a tailored 3-D metal body. Subsequently, a second metal powder of a second powder supply may be used as a second metal powder bed layer to produce a second region (500) of a tailored 3-D metal body (e.g., as per FIG. 1c or FIG. 2), or may be blended with the first metal powder prior to being provided to the build reservoir (e.g., as per FIG. 2). In one embodiment, the second metal powder consists of another mixture of one-metal particles and M-NM particles. In another embodiment, the second metal powder consists of one-metal particles. In yet another embodiment, the second metal powder consists of one-metal particles and multiple-metal particles. In another embodiment, the second metal powder consists of one-metal particles, multiple-metal particles and M-NM particles. In yet another embodiment, the second metal powder consists of multiple-metal particles. In another embodiment, the second metal powder consists of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder of a first powder supply consists of a mixture of one-metal particles, multiple-metal particles and M-NM particles. The first metal powder may be used in a first metal powder bed layer to produce a first region (400) of a tailored 3-D metal body. Subsequently, a second metal powder of a second powder supply may be used as a second metal powder bed layer to produce a second region (500) of a tailored 3-D metal body (e.g., as per FIG. 1c or FIG. 2), or may be blended with the first metal powder prior to being provided to the build reservoir (e.g., as per FIG. 2). In one embodiment, the second metal powder consists of another mixture of one-metal particles, multiple-metal particles and M-NM particles. In another embodiment, the second metal powder consists of one-metal particles. In yet another embodiment, the second metal powder consists of one-metal particles and multiple-metal particles. In another embodiment, the second metal powder consists of one-metal particles and M-NM particles. In yet another embodiment, the second metal powder consists of multiple-metal particles. In another embodiment, the second metal powder consists of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder of a first powder supply consists of a mixture of multiple-metal particles and M-NM particles. The first metal powder may be used in a first metal powder bed layer to produce a first region (400) of a tailored 3-D metal body. Subsequently, a second metal powder of a second powder supply may be used as a second metal powder bed layer to produce a second region (500) of a tailored 3-D metal body (e.g., as per FIG. 1c or FIG. 2), or may be blended with the first metal powder prior to being provided to the build reservoir (e.g., as per FIG. 2). In one embodiment, the second metal powder consists of another mixture of multiple-metal particles and M-NM particles. In another embodiment, the second metal powder consists of one-metal particles. In yet another embodiment, the second metal powder consists of one-metal particles and multiple-metal particles. In another embodiment, the second metal powder consists of one-metal particles and M-NM particles. In yet another embodiment, the second metal powder consists of multiple-metal particles. In another embodiment, the second metal powder consists of one-metal particles, multiple-metal particles and M-NM particles. In yet another embodiment, the second metal powder consists of M-NM particles. In any of these embodiments, non-metal particles may be optionally used in the second metal powder to produce the second region.

Thus, the systems and apparatus of FIGS. 1a-1c and 2 may be useful in producing a variety of additively manufactured 3-D metal products, such as any of the single or multi-region products illustrated in FIGS. 3a-3f, 4, and 5a-5d, and with any suitable metals, including aluminum-based, titanium-based, cobalt-based, nickel-based, and iron-based 3-D metal products, where at least a first region of the additively manufactured 3-D metal products comprises one of these metal-based products.

While various embodiments of the new technology described herein have been described in detail, it is apparent that modifications and adaptations of those embodiments will occur to those skilled in the art. However, it is to be expressly understood that such modifications and adaptations are within the spirit and scope of the presently disclosed technology.

What is claimed is:

1. A method comprising:
first gathering a first feedstock from a first powder supply of an additive manufacturing system;
second gathering a second feedstock from a second powder supply of the additive manufacturing system;
wherein at least one of the first feedstock and the second feedstock includes metal particles therein;
combining the first and second feedstocks, thereby producing a metal powder blend;
providing the metal powder blend to a build space of the additive manufacturing system.

2. The method of claim 1, wherein the first gathering comprises mechanically pushing the first feedstock via a roller, and wherein the second gathering comprises mechanically pushing the second feedstock via the roller.

3. The method of claim 2, comprising:
pushing the first feedstock towards the second feedstock via the roller.

4. The method of claim 3, wherein the providing step comprises:
pushing the metal powder blend from downstream of the second powder supply to the build space.

5. The method of claim 1, wherein the first gathering step comprises:
adjusting a height of a platform of the first powder supply, thereby providing a first volume of the first feedstock for the first gathering step.

6. The method of claim 5, comprising:
after the first gathering step, moving the height of the platform, thereby providing a third feedstock, wherein the third feedstock is a second volume of the first feedstock.

7. The method of claim 6, comprising:
third gathering the third feedstock from the first powder supply;
fourth gathering a second feedstock from the second powder supply; and
combining the third feedstock and the second feedstock.

8. The method of claim 7, wherein the second gathering and the fourth gathering steps gather an equivalent volume of the second feedstock.

9. The method of claim 1, comprising:
producing a tailored 3-D metal product in the build space of the additive manufacturing system using the metal powder blend.

10. The method of claim 9, wherein the 3-D metal product is an oxide dispersion strengthened 3-D metal alloy product having M-O particles therein, wherein M is a metal and O is oxygen.

11. The method of claim 10, wherein the oxide dispersion strengthened 3-D metal alloy product comprises a sufficient amount of the M-O particles to facilitate oxide dispersion strengthening, and wherein the oxide dispersion strengthened 3-D metal alloy product comprises not greater than 10 wt. % of the M-O particles.

12. The method of claim 11, wherein the M-O particles are selected from the group consisting of Y₂O₃, Al₂O₃, TiO₂, La₂O₃, and combinations thereof.

13. An additive manufacturing system, comprising:
a first powder supply having a first powder reservoir for distributing a first powder feedstock;
a second powder supply downstream of the first powder supply, wherein the second powder supply has a second powder reservoir for distributing a second powder feedstock;
a powder spreader configured to:
(a) gather the first powder feedstock from the first powder supply;
(b) gather the second powder feedstock from the second powder supply;
(c) move at least from the first powder supply to the second powder supply;
(d) move from at least one of the first and second powder supplies to a build space for building an additive manufacturing product, wherein the build space is downstream of the second powder supply, and wherein the build space comprises a build reservoir for receiving powder feedstock.

14. The additive manufacturing system of claim 13, comprising:
a distribution surface associated with the first powder supply, the second powder supply and the build space;
wherein the powder spreader is configured to move along the distribution surface with at least one of the first and second powder feedstocks.

15. The additive manufacturing system of claim 14, wherein the first powder supply comprises:
a first platform disposed within the first powder reservoir, wherein the first platform is configured to move longitudinally up and down within the first powder reservoir;
wherein the first powder reservoir is configured to contain the first powder feedstock;
wherein the first platform is controllable by a controller to provide a controlled volume of the first powder feedstock relative to the distribution surface.

16. The additive manufacturing system of claim 15, wherein the distribution surface is disposed above the first platform.

17. The additive manufacturing system of claim 16, wherein the powder spreader is configured to move along the distribution surface from the first powder reservoir to the second powder reservoir.

18. The additive manufacturing system of claim 17, wherein the powder spreader is configured to move along the distribution surface from the second powder reservoir to the build reservoir.

19. The additive manufacturing system of claim 17, comprising a vibratory apparatus disposed between the second powder reservoir and the build reservoir.

20. The additive manufacturing system of claim 14, wherein the distribution surface is planar and defines an upper working surface for the powder spreader.
